(19) United States
(12) Patent Application Publication
(10) Pub. No.: US 2021/0083334 A1
(43) Pub. Date: Mar. 18, 2021

(54) METHOD OF RESTORING CAPACITY OF NON-AQUEOUS ELECTROLYTE SECONDARY BATTERY AND NON-AQUEOUS ELECTROLYTE SECONDARY BATTERY

(71) Applicant: TOYOTA JIDOSHA KABUSHIKI KAISHA, Toyota-shi (JP)

(72) Inventors: Katsuhiko NAGAYA, Toyota-shi (JP); Shinobu OKAYAMA, Miyoshi-shi (JP); Yukimasa NISHIDE, Toyota-shi (JP); Nobuhiro OGIHARA, Nagakute-shi (JP); Yasuhito KONDO, Nagakute-shi (JP); Tsuyoshi SASAKI, Nagakute-shi (JP)

(73) Assignee: TOYOTA JIDOSHA KABUSHIKI KAISHA, Toyota-shi (JP)

(21) Appl. No.: 17/004,247

(22) Filed: Aug. 27, 2020

(30) Foreign Application Priority Data
Sep. 12, 2019 (JP) 2019-165831
May 20, 2020 (JP) 2020-088054

(51) Int. Cl. H01M 10/42; H01M 10/0569; H01M 10/44; H01M 10/0568

(52) U.S. Cl. CPC H01M 10/4242; H01M 10/0568; H01M 10/44; H01M 10/0569

(57) ABSTRACT

A liquid composition is for use to feed carrier ions to a non-aqueous electrolyte secondary battery. The liquid composition includes a solvent and a dissolved substance. The dissolved substance includes an ionic compound. The ionic compound consists of a radical anion of an aromatic compound and a metal cation. The aromatic compound is a polyacene or a polyphenyl. The metal cation is an ion of the same type as the carrier ions.

This nonprovisional application is based on Japanese Patent Application No. 2019-165831 filed on Sep. 12, 2019, and No. 2020-088054 filed on May 20, 2020, with the Japan Patent Office, the entire contents of which are hereby incorporated by reference.

### BACKGROUND

### Field

The present disclosure is related to a liquid composition, a method of restoring capacity of a non-aqueous electrolyte secondary battery, a method of producing a liquid composition, and a non-aqueous electrolyte secondary battery.

### Description of the Background Art

Japanese Patent Laying-Open No. 2016-076358 discloses a third electrode for feeding lithium ions to a positive electrode.

### SUMMARY

In a non-aqueous electrolyte secondary battery (which may be simply called “a battery” hereinafter), it is typical that carrier ions travel between a positive electrode and a negative electrode and thereby charge and discharge occur.

The amount of carrier ions, which contribute to charge and discharge, can decrease due to battery use. For instance, as reduction and degradation of the electrolyte solution occur, a film is formed on a surface of the negative electrode. Into this film, part of carrier ions can be trapped. When part of carrier ions released from the positive electrode are thus trapped in the film instead of being inserted into the negative electrode, this causes a difference between the charge amount in the positive electrode and the charge amount in the negative electrode. This difference in charge amount between the positive electrode and the negative electrode may cause a decrease in the battery capacity.

As an example method for resolving this difference in charge amount between the positive electrode and the negative electrode, supplying carrier ions solely to the positive electrode without supplying carrier ions to the negative electrode may be considered. However, by means of normal charging and discharging, it is difficult to supply carrier ions solely to the positive electrode.

Japanese Patent Laying-Open No. 2016-076358 proposes providing a third electrode for feeding carrier ions, in addition to a positive electrode and a negative electrode. In Japanese Patent Laying-Open No. 2016-076358, the third electrode is externally short-circuited with the positive electrode for allowing carrier ions (lithium ions) to move from the third electrode to the positive electrode. By supplying carrier ions solely to the positive electrode, a difference in charge amount between the positive electrode and the negative electrode may be resolved.

However, incorporating a third electrode into a battery may make the battery structure complicated. Further, changing connection between the electrodes may also be complicated. From the viewpoint of easy and simple operation, there may be room for improvement.

An object of the present disclosure is to feed carrier ions that contribute to charge and discharge, in an easy and simple way.

In the following, the technical structure and the effects according to the present disclosure are described. It should be noted that the action mechanism according to the present disclosure includes presumption. Therefore, the scope of claims should not be limited by whether or not the action mechanism is correct.

[1] A liquid composition according to the present disclosure is for use to feed carrier ions to a non-aqueous electrolyte secondary battery. The liquid composition includes a solvent and a dissolved substance. The dissolved substance includes an ionic compound. The ionic compound consists of a radical anion of an aromatic compound and a metal cation. The aromatic compound is a polyacene or a polyphenyl. The metal cation is an ion of the same type as the carrier ions.

According to the present disclosure, novel properties and novel applications of the liquid composition is provided. More specifically, mixing the liquid composition with an electrolyte solution in the battery makes it possible to supply carrier ions solely to a positive electrode. By this, carrier ions that contribute to charge and discharge may be fed. In the case of capacity loss occurred due to a difference in charge amount between the positive electrode and the negative electrode, the capacity may be increased. In other words, the capacity may be restored.

For instance, when the battery has an openable casing, the casing may be opened and thereby the liquid composition may be introduced into the battery. Thereby, the liquid composition may be mixed with the electrolyte solution in the battery. In other words, according to the present disclosure, there may be substantially no need for a complicated structure.

After the liquid composition is mixed with the electrolyte solution, the battery may be simply left to itself to allow carrier ions to be fed to the positive electrode. In other words, according to the present disclosure, there may be substantially no need for complicated operation.

[2] In the liquid composition according to [1] above,

the dissolved substance may include, for example, at least one type selected from the group consisting of:

a first ionic compound represented by the following formula (1):

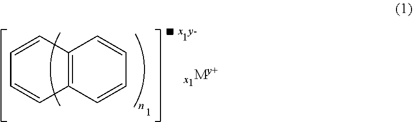

and a second ionic compound represented by the following formula (2).

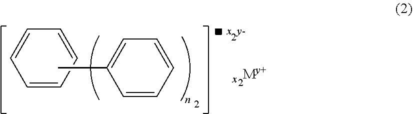

In the formula (1) and the formula (2) above,

each of n₁ and n₂ is an integer of 1 to 4,

each of x₁ and x₂ is any numeral,

M^{y+} denotes the metal cation,

y denotes a valence of the metal cation,

each aromatic ring may include a heteroatom in the ring, and

each aromatic ring may have a substituent on the ring.

[3] In the liquid composition according to [2] above,

the radical anion may include at least one type selected from the group consisting of a naphthalene radical anion and a biphenyl radical anion.

[4] In the liquid composition according to any one of [1] to [3],

the metal cation may include a lithium ion, for example.

[5] In the liquid composition according to any one of [1] to [4] above,

the solvent may include, for example, at least one type selected from the group consisting of tetrahydrofuran and 1,2-dimethoxyethane.

[6] A method of restoring capacity of a non-aqueous electrolyte secondary battery according to the present disclosure includes the following (A) and (B):

(A) preparing a liquid composition; and

(B) mixing the liquid composition with an electrolyte solution of the non-aqueous electrolyte secondary battery having an observed capacity loss from a predetermined capacity.

The liquid composition includes a solvent and a dissolved substance. The dissolved substance includes an ionic compound. The ionic compound consists of a radical anion of an aromatic compound and a metal cation. The aromatic compound is a polyacene or a polyphenyl. The metal cation is an ion of the same type as the carrier ions of the non-aqueous electrolyte secondary battery.

When the liquid composition according to the present disclosure is mixed with the electrolyte solution of the non-aqueous electrolyte secondary battery, the capacity of the non-aqueous electrolyte secondary battery may be restored.

[7] The method of restoring capacity of a non-aqueous electrolyte secondary battery according to the present disclosure may further include the following (J):

(J) after the liquid composition is mixed with the electrolyte solution of the non-aqueous electrolyte secondary battery, performing constant current-constant voltage charging of the non-aqueous electrolyte secondary battery.

In this way, when the liquid composition is mixed with the electrolyte solution of the battery, the capacity of the battery may be restored. Further, by subsequently performing constant current-constant voltage (CCCV) charging of the battery, cycle resistance may be improved, for example. The “cycle resistance” herein refers to having less tendency to capacity loss occurring due to charge-discharge cycles.

The “CCCV charging” refers to a type of charging where constant-current (CC) charging and constant-voltage (CV) charging are performed alternately. For example, CC charging may be first performed and then CV charging may be performed. For example, CV charging may be first performed and then CC charging may be performed. For example, CC charging and CV charging and CC charging may be performed in this order.

For example, CC charging may first be performed until a predetermined state of charge (SOC) is reached. After the predetermined SOC is reached, CV charging may be performed.

In the “CC charging”, charging is performed with a substantially constant current. In the “CV charging”, charging is performed at a substantially constant voltage. In the CV charging, electric current is supplied to the battery in such a way that the voltage of the battery is maintained substantially constant. The “SOC” refers to the percentage of remaining capacity to the full charge capacity of the battery. For example, 100% SOC means a full-charge state, and 0% SOC means a completely discharged state.

For example, the liquid composition according to the present disclosure may have a high activity. When the liquid composition has a high activity, the capacity of the battery may tend to decrease during charge-discharge cycles. By CCCV charging, the activity of the liquid composition may be decreased, for example. As a result, cycle resistance may be improved.

[8] In the method of restoring capacity of a non-aqueous electrolyte secondary battery according to [7] above, the constant current-constant voltage charging may include performing constant voltage charging of the non-aqueous electrolyte secondary battery in a 90% to 100% charged state.

For example, when CV charging is performed at a high SOC from 90% to 100%, the activity of the liquid composition may tend to be decreased.

[9] A method of producing a liquid composition according to the present disclosure includes the following (a) and (b):

(a) preparing a precursor solution by dissolving an aromatic compound in a solvent; and

(b) producing a liquid composition by dissolving a metal in the precursor solution.

The aromatic compound is a polyacene or a polyphenyl. A metal cation generated from the metal is an ion of the same type as the carrier ions.

For example, by the production method according to [9] above, the liquid composition according to [1] above may be produced.

A method of producing a non-aqueous electrolyte secondary battery according to the present disclosure includes the following (A) and (B):

(A) preparing the liquid composition according to any one of [1] to [5] above; and

(B) mixing the liquid composition with an electrolyte solution of the non-aqueous electrolyte secondary battery.

By the method of producing a non-aqueous electrolyte secondary battery according to the present disclosure, a battery with an increased capacity may be produced.

[10] A non-aqueous electrolyte secondary battery according to the present disclosure includes a positive electrode, a negative electrode, and an electrolyte solution.

The electrolyte solution includes a radical anion of an aromatic compound and a carrier ion. The aromatic compound is a polyacene or a polyphenyl.

In the battery according to the present disclosure, carrier ion feeding may have an effect such as mitigation of capacity loss occurring due to battery use, for example.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic flowchart of a method of producing a liquid composition according to the present embodiment.

FIG. 2 is a first schematic flowchart of a method of restoring capacity of a non-aqueous electrolyte secondary battery according to the present embodiment.

FIG. 3 is a first schematic flowchart of a method of producing a non-aqueous electrolyte secondary battery according to the present embodiment.

FIG. 4 is a schematic view illustrating an example configuration of a non-aqueous electrolyte secondary battery according to the present embodiment.

FIG. 5 is a second schematic flowchart of the method of restoring capacity of a non-aqueous electrolyte secondary battery according to the present embodiment.

FIG. 6 is a second schematic flowchart of the method of producing a non-aqueous electrolyte secondary battery according to the present embodiment.

FIG. 7 is a graph illustrating results of charge-discharge cycles in Experiment 2.

### DESCRIPTION OF THE PREFERRED EMBODIMENTS

In the following, embodiments of the present disclosure (herein also called “present embodiment”) are described. However, the description below does not limit the scope of claims.

In the present embodiment, such phrases as “from 0.05 mol/L to 1.00 mol/L” mean a range that includes the boundary values, unless otherwise specified. As a specific example, the phrase “from 0.05 mol/L to 1.00 mol/L” means a range of “not less than 0.05 mol/L and not more than 1.00 mol/L”.

<Liquid Composition>

A liquid composition according to the present embodiment is for use to feed carrier ions to a battery. The battery is described below in detail. Feeding carrier ions may increase or restore the capacity of the battery. The liquid composition may also be called “carrier-ion-feeding agent” and “capacity-restoring agent”, for example. The liquid composition includes a solvent and a dissolved substance.

<<Dissolved Substance>>

The dissolved substance is dissolved in the solvent. The dissolved substance includes an ionic compound. The ionic compound contributes to feeding carrier ions. The dissolved substance may include one type of the ionic compound. The dissolved substance may include two or more types of the ionic compound.

In the present embodiment, the dissolved substance may have any concentration. The concentration of the dissolved substance may be selected in accordance with, for example, a balance between the amount of dead space inside the battery and the amount of carrier ions to feed. For instance, when the concentration is too low, the volume of the liquid composition may be too large to supply a sufficient amount into the battery. For instance, when the concentration is too high, a long time may be required for the liquid composition to be incorporated with an electrolyte solution.

The dissolved substance may have a concentration from 0.05 mol/L to 1.00 mol/L, for example. When the concentration of the dissolved substance is 0.05 mol/L or more, carrier ion feeding may be facilitated. When the concentration of the dissolved substance is 1.00 mol/L or less, carrier ion feeding may be facilitated. The dissolved substance may have a concentration from 0.10 mol/L to 0.50 mol/L, for example. The dissolved substance may have a concentration from 0.05 mol/L to 0.10 mol/L, for example. The dissolved substance may have a concentration from 0.50 mol/L to 1.00 mol/L, for example.

(Ionic Compound)

The ionic compound consists of a radical anion of an aromatic compound and a metal cation. The ionic compound may be either dissociated or associated. The metal cation is an ion of the same type as the carrier ions of the battery. When the battery is a lithium-ion battery, for example, both the carrier ion and the metal cation are lithium (Li) ions. In other words, the metal cation may include a Li ion, for example. When the battery is a sodium-ion battery, for example, both the carrier ion and the metal cation are sodium (Na) ions. When the battery is a magnesium-ion battery, for example, both the carrier ion and the metal cation are magnesium (Mg) ions.

The aromatic compound is a polyacene or a polyphenyl. The polyacene has a structure that includes multiple condensed aromatic rings. In the present embodiment, each aromatic ring of the polyacene may include a heteroatom in the ring. The heteroatom may be nitrogen (N), oxygen (O), and/or sulfur (S), for example. Each aromatic ring of the polyacene may have a substituent on the ring. The polyphenyl has a structure that includes a plurality of phenyl groups bonded via single bonds. In the present embodiment, each aromatic ring of the polyphenyl may include a heteroatom in the ring. Each aromatic ring of the polyphenyl may have a substituent on the ring.

In the present embodiment, an ionic compound in which the aromatic compound is a polyacene is called “a first ionic compound”, and an ionic compound in which the aromatic compound is a polyphenyl is called “a second ionic compound”.

The dissolved substance may include at least one type selected from the group consisting of the first ionic compound and the second ionic compound.

(First Ionic Compound)

The first ionic compound is represented by the following formula (1).

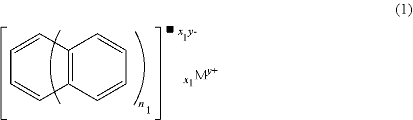

In the formula (1) above, n₁ is an integer of 1 to 4; xᵢ is any numeral; M^{y+} denotes the metal cation; y denotes the valence of the metal cation; each aromatic ring may include a heteroatom in the ring; and each aromatic ring may have a substituent on the ring.

The first ionic compound includes a radical anion of a polyacene. The polyacene may be an aromatic hydrocarbon. The polyacene may be naphthalene, anthracene, tetracene, and/or pentacene, for example. The polyacene may include a heteroatom in the ring. The polyacene may be quinoline, chromene, and/or acridine, for example.

The first ionic compound may be lithium naphthalenide, for example. Lithium naphthalenide consists of a naphthalene radical anion and a Li ion.

(Second Ionic Compound)

The second ionic compound is represented by the following formula (2).

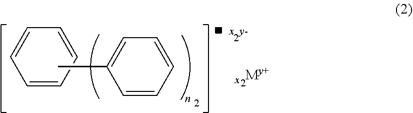

In the formula (2) above, n₂ is an integer of 1 to 4; x₂ is any numeral; M^{y+} denotes the metal cation; y denotes the valence of the metal cation; each aromatic ring may include a heteroatom in the ring; and each aromatic ring may have a substituent on the ring.

The second ionic compound includes a radical anion of a polyphenyl. The polyphenyl may be a hydrocarbon. The polyphenyl may be biphenyl, o-terphenyl, m-terphenyl, p-terphenyl, p-quaterphenyl, and/or p-quinquephenyl, for example. The polyphenyl may include a heteroatom in the ring. The polyphenyl may be bipyridine, for example.

The second ionic compound may be lithium biphenylide, for example. Lithium biphenylide consists of a biphenyl radical anion and a Li ion.

In the first ionic compound and the second ionic compound, the substituent that may be introduced on the ring may be, for example, a halogen atom, an alkyl group, an aryl group, an alkenyl group, an alkoxy group, an aryloxy group, a sulfonyl group, an amino group, a cyano group, a carbonyl group, an acyl group, an amido group, and/or a hydroxy group. Each of the first ionic compound and the second ionic compound may have one type of the substituent. Each of the first ionic compound and the second ionic compound may have a plurality of the substituents. The “plurality” herein means at least one of “a plurality in number” and “a plurality in type”.

<<Solvent>>

When the dissolved substance is in a state of dissolution in the solvent, stability of the ionic compound may be improved, for example. The solvent is not particularly limited as long as the dissolved substance can be dissolved in it. For example, the solvent may solely consist of one component. For example, the solvent may consist of a plurality of components. For example, the solvent may include a cyclic ether, a chain ether, and the like. For example, the solvent may include at least one type selected from the group consisting of tetrahydrofuran (THF), 1,3-dioxolane (DOL), 1,4-dioxane (DX), 1,2-dimethoxyethane (DME), and 1,2-diethoxyethane (DEE). For example, the solvent may include at least one type selected from the group consisting of THF and DME.

<<Other Components>>

The liquid composition according to the present embodiment may further include an optional component in addition to the above-described components. For example, the liquid composition may include a component capable of facilitating the dissociation of the ionic compound.

<Method of Using Liquid Composition, Use of Liquid Composition>

In the present embodiment, a method of using a liquid composition is also provided.

The method of using a liquid composition according to the present embodiment includes:

preparing a liquid composition; and

using the liquid composition for feeding carrier ions to a non-aqueous electrolyte secondary battery.

The liquid composition includes a solvent and a dissolved substance. The dissolved substance includes an ionic compound. The ionic compound consists of a radical anion of an aromatic compound and a metal cation. The aromatic compound is a polyacene or a polyphenyl. The metal cation is an ion of the same type as the carrier ions of the non-aqueous electrolyte secondary battery.

The use of a liquid composition according to the present embodiment is a use of a liquid composition for feeding carrier ions to a non-aqueous electrolyte secondary battery.

The liquid composition includes a solvent and a dissolved substance. The dissolved substance includes an ionic compound. The ionic compound consists of a radical anion of an aromatic compound and a metal cation. The aromatic compound is a polyacene or a polyphenyl. The metal cation is an ion of the same type as the carrier ions of the non-aqueous electrolyte secondary battery.

<Method of Producing Liquid Composition>

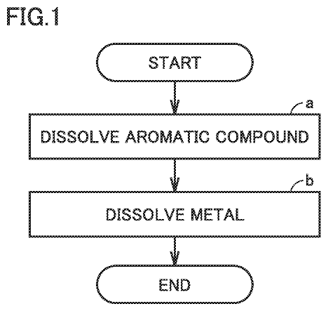

FIG. 1 is a schematic flowchart of a method of producing a liquid composition according to the present embodiment. The method of producing a liquid composition according to the present embodiment includes “(a) dissolving an aromatic compound” and “(b) dissolving a metal”.

<<(a) Dissolving Aromatic Compound>>

The method of producing a liquid composition according to the present embodiment includes preparing a precursor solution by dissolving an aromatic compound in a solvent.

The dissolving an aromatic compound may be performed, for example, in an environment with a low dew point. For example, the dissolving may be performed in an argon (Ar) atmosphere. The environment with a low dew point may be an environment with a dew point equal to or lower than −20° C., for example. The environment with a low dew point may be an environment with a dew point equal to or lower than −40° C., for example. The environment with a low dew point may be an environment with a dew point equal to or lower than −60° C., for example.

The dissolving an aromatic compound may be performed, for example, in an environment at room temperature. In order to facilitate the dissolution of the aromatic compound, warming and/or the like may be performed, for example.

The aromatic compound is a precursor of the radical anion. For example, powder of the aromatic compound may be prepared. The powder of the aromatic compound is added to the solvent. For achieving substantially complete dissolution of the aromatic compound, the mixture is sufficiently stirred. By this, a precursor solution may be prepared.

<<(b) Dissolving Metal>>

The method of producing a liquid composition according to the present embodiment includes producing a liquid composition by dissolving a metal in the precursor solution.

The dissolving a metal may be continuously performed in the environment with a low dew point. The dissolving a metal may be performed, for example, in an environment at room temperature. In order to facilitate the dissolution of the metal, warming and/or the like may be performed, for example. The metal is a precursor of the metal cation. In order to facilitate the dissolution of the metal, the metal may be machined into a shape with a large surface area, for example.

The metal is added into the precursor solution. The molar ratio of the metal to the aromatic compound may be “metal/(aromatic compound)=1/1”, for example. For achieving substantially complete dissolution of the metal, the mixture is sufficiently stirred.

When the aromatic compound is a polyacene, the reaction of the following formula (3), for example, may proceed to produce a first ionic compound.

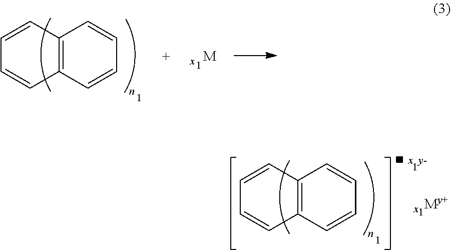

When the aromatic compound is a polyphenyl, the reaction of the following formula (4), for example, may proceed to produce a second ionic compound.

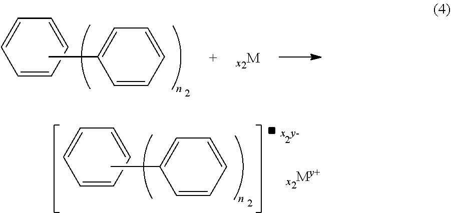

In the above-described manner, the liquid composition according to the present embodiment is produced. After the liquid composition is produced, the liquid composition may be diluted or concentrated in such a way that the dissolved substance has a predetermined concentration. For example, the liquid composition may be diluted or concentrated in such a way that the dissolved substance has a concentration from 0.05 mol/L to 1.00 mol/L.

<Method of Restoring Capacity of Non-Aqueous Electrolyte Secondary Battery>

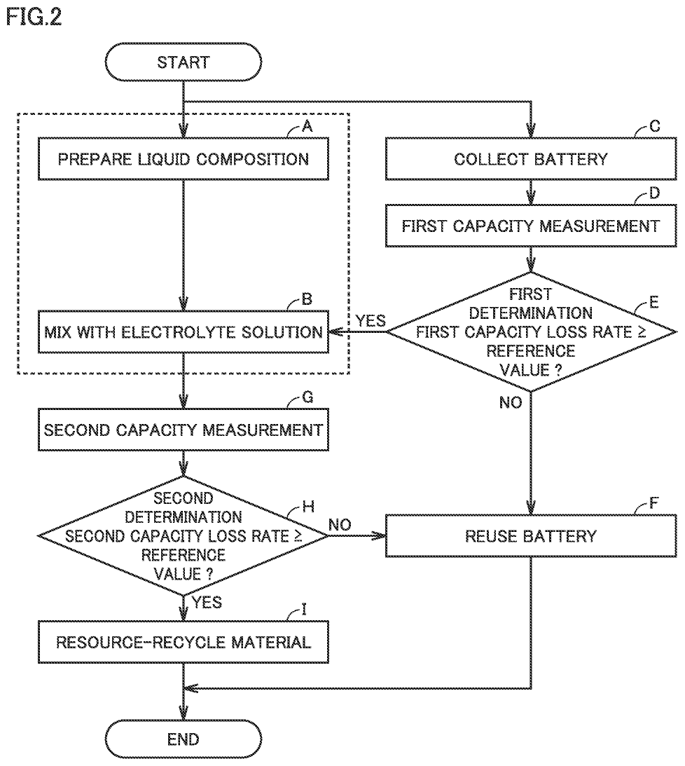

FIG. 2 is a first schematic flowchart of a method of restoring capacity of a non-aqueous electrolyte secondary battery according to the present embodiment. The method of restoring capacity of a battery according to the present embodiment includes “(A) preparing a liquid composition” and “(B) mixing with an electrolyte solution”. The method of restoring capacity of a battery according to the present embodiment may further include “(C) collecting a battery”, “(D) first capacity measurement”, “(E) first determination”, “(F) reusing the battery”, “(G) second capacity measurement”, “(H) second determination”, “(I) resource-recycling the material”, and the like.

<<(A) Preparing Liquid Composition>>

The method of restoring capacity of a battery according to the present embodiment includes preparing a liquid composition. The liquid composition may be prepared by any method. For example, the liquid composition may be produced by the above-described method of producing a liquid composition. As described above, the liquid composition includes a solvent and a dissolved substance; the dissolved substance includes an ionic compound; the ionic compound consists of a radical anion of an aromatic compound and a metal cation; the aromatic compound is a polyacene or a polyphenyl; and the metal cation is an ion of the same type as the carrier ions.

<<(B) Mixing with Electrolyte Solution>>

The method of restoring capacity of a battery according to the present embodiment includes mixing the liquid composition with an electrolyte solution of the battery having an observed capacity loss from a predetermined capacity.

For example, by a predetermined means, a casing of the battery is opened. When the casing has a liquid inlet, the liquid inlet is opened. Through the liquid inlet, the liquid composition is injected into the battery. Thereby, the liquid composition and the electrolyte solution may be mixed in the battery. For facilitating the incorporation, the battery may be gently shaken, for example.

The amount of the liquid composition used may be selected in accordance with, for example, the concentration of the liquid composition and the amount of carrier ions to feed. The amount of carrier ions to feed may be calculated from, for example, results of “(D) first capacity measurement” described below. For example, the amount of capacity loss (as quantity of electricity) may be converted into the number of moles of carrier ions and thereby the amount of carrier ions to feed may be calculated. The amount of the liquid composition used may be selected to be proper in relation to the amount of carrier ions to feed. When the amount of the liquid composition used is too high, for example, it is improper. When the amount is too high, an excessive amount of carrier ions may be supplied to a positive electrode to deteriorate a positive electrode active material.

After the liquid composition is mixed with the electrolyte solution, the battery is left to itself. By this, the metal cations in the liquid composition may be supplied to the positive electrode. In other words, carrier ions that contribute to charge and discharge may be fed. For example, the battery may be left to itself in an environment at a temperature from 0° C. to 80° C. For example, the battery may be left to itself in an environment at room temperature. The duration for leaving may be from 1 hour to 48 hours, for example. The duration for leaving may be 6 hours to 24 hours, for example.

It is considered that the driving force for the reaction according to the present embodiment is the difference between the electric potential of the electrolyte solution containing the liquid composition mixed therein and the electric potential of the positive electrode. Therefore, the higher the SOC of the battery is, the more facilitated the movement of the metal cations may be, for example. It may be because, the higher the SOC is, the higher the electric potential of the positive electrode is, and the larger the potential difference between the electrolyte solution and the positive electrode is. However, when the SOC is too high, the material inside the battery may tend to deteriorate while the battery is opened. At the time of mixing the liquid composition, the SOC of the battery may be from 10% to 100%, for example. At the time of mixing the liquid composition, the SOC of the battery may be from 30% to 80%, for example. At the time of mixing the liquid composition, the SOC of the battery may be from 40% to 60%, for example.

<<(C) Collecting Battery>>

The method of restoring capacity of a battery according to the present embodiment may include collecting a battery. The battery may be collected by any method. For example, a used battery may be collected from the market. For example, a used battery may be collected during inspection and/or the like of, for example, a vehicle having a battery mounted thereon.

<<(D) First Capacity Measurement>>

The method of restoring capacity of a battery according to the present embodiment may include measuring the capacity of the battery thus collected to calculate a first capacity loss rate. The capacity measurement may be performed with a typical charge-discharge apparatus. The first capacity loss rate (unit, %) may be calculated by the mathematical expression below.

First capacity loss rate={(C₀−C₁)/C₀}×100

In the above mathematical expression, C₀ denotes the initial capacity and C₁ denotes the capacity measured after collection. For example, the rated capacity of the battery may be regarded as the initial capacity.

<<(E) First Determination>>

The method of restoring capacity of a battery according to the present embodiment may include determining whether capacity restoration is required based on the first capacity loss rate. For example, when the first capacity loss rate is equal to or higher than a reference value, the process may proceed to “(B) mixing with an electrolyte solution”. In other words, the liquid composition may be mixed with the electrolyte solution of the battery having an observed capacity loss from a predetermined capacity. The reference value may be selected optionally in accordance with the applications of the battery, the environment of use of the battery, and the like.

Instead of capacity, other properties may be measured. For example, resistance measurement and/or the like may be performed. From results of the resistance measurement, whether capacity restoration is required may be determined. From results of the capacity measurement and the resistance measurement, whether capacity restoration is required may be determined.

<<(F) Reusing Battery>>

In the above-described “(E) first determination”, when the first capacity loss rate is lower than the reference value, for example, the battery may be reused as it is. The battery may be reused in the same application as the application at the time of collection. The battery may be reused in an application that is different from the application at the time of collection.

<<(G) Second Capacity Measurement>>

The method of restoring capacity of a battery according to the present embodiment may include, after the liquid composition is mixed, measuring the capacity to calculate a second capacity loss rate. The second capacity loss rate may be calculated in the same manner as in the calculation of the first capacity loss rate.

<<(H) Second Determination>>

The method of restoring capacity of a battery according to the present embodiment may include determining, based on the second capacity loss rate, whether resource-recycling of the material is required. For example, when the second capacity loss rate is equal to or higher than a reference value, the process may proceed to “(I) resource-recycling the material”. For example, when the second capacity loss rate is lower than the reference value, the process may proceed to the above-described “(F) reusing the battery”; in other words, it may be considered that the capacity is sufficiently restored for reusing the battery.

<<(I) Resource-Recycling Material>>

In the above-described “(H) second determination”, when the second capacity loss rate is equal to or higher than a reference value, for example, it may be regarded as reusing the battery is difficult. The battery may be disassembled for collection of various materials (for example, rare metals).

<<(J) CCCV Charging>>

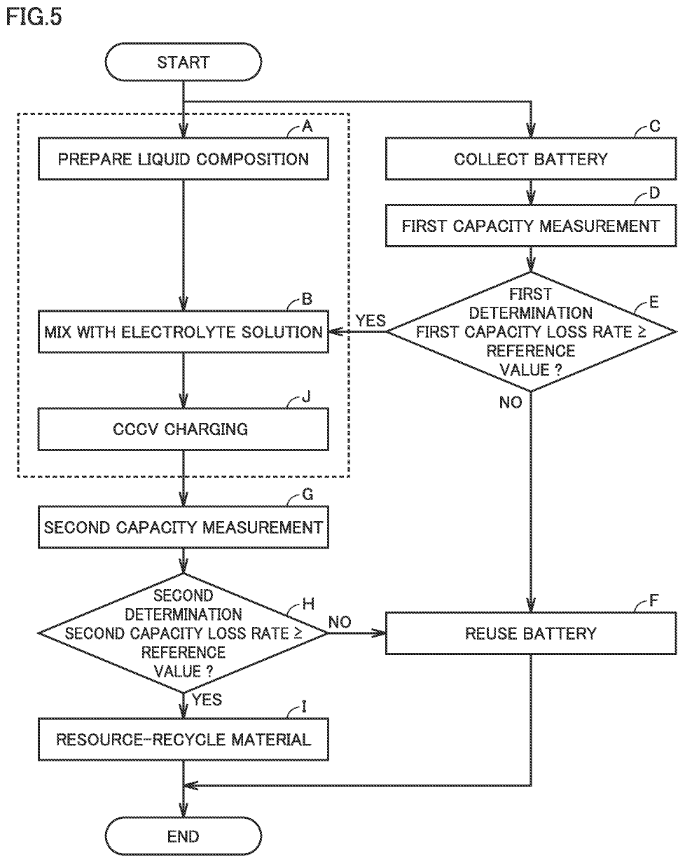

FIG. 5 is a second schematic flowchart of the method of restoring capacity of a non-aqueous electrolyte secondary battery according to the present embodiment. The second schematic flowchart of FIG. 5 is the same as the first schematic flowchart of FIG. 2 with the addition of “(J) CCCV charging”.

The method of restoring capacity of a battery according to the present embodiment may further include “(J) CCCV charging” after “(B) mixing with an electrolyte solution”. More specifically, the method of restoring capacity of a battery according to the present embodiment may further include, after the liquid composition is mixed with the electrolyte solution of the battery, performing CCCV charging of the battery. CCCV charging may improve cycle resistance, for example.

A charging apparatus capable of performing CCCV charging is prepared. In the present embodiment, any charging apparatus may be used as long as it is capable of performing CCCV charging. For example, a charge-discharge apparatus may be used. During charging, the temperature of the battery may be controlled. During charging, the ambient temperature of the battery may be from 10° C. to 40° C., for example. During charging, the ambient temperature of the battery may be from 20° C. to 30° C., for example.

In the CCCV charging, CC charging and CV charging are performed alternately. For example, in the CCCV charging, CC charging may be performed first and then CV charging may be performed. For example, in the CCCV charging, CV charging may be performed first and then CC charging may be performed. CC charging and CV charging may be performed without a pause in-between. CC charging and CV charging may be performed with a pause in-between, for example.

The CC charging is performed with a substantially constant current. For example, the rate during the CC charging may be from 0.1 C to 2 C. For example, the rate during the CC charging may be from 0.1 C to 1 C. For example, the rate during the CC charging may be from 0.3 C to 0.7 C. The “C” herein is a symbol representing the magnitude of rate. At a rate of 1 C, fully discharging a battery from its full charge capacity completes in one hour.

The CC charging ends when the SOC of the battery reaches the cut-off SOC, for example. After the CC charging ends, charging is switched to CV charging. The cut-off SOC may be from 80% to 100%, for example. The cut-off SOC may be from 90% to 100%, for example.

In the CV charging, electric current is supplied to the battery in such a way that the voltage of the battery is maintained substantially constant. During the CV charging, the electric current decays. The CCCV charging according to the present embodiment may include performing CV charging of the battery at an SOC from 80% to 100%, for example. The CCCV charging according to the present embodiment may include performing CV charging of the battery at an SOC from 90% to 100%, for example. When the CV charging is performed at a high SOC, the activity of the liquid composition may tend to be decreased.

In the CV charging, the voltage of the battery may be from 3.7 V to 4.3 V, for example. In the CV charging, the voltage of the battery may be from 3.8 V to 4.2 V, for example. In the CV charging, the voltage of the battery may be from 3.9 V to 4.1 V, for example.

The liquid composition according to the present embodiment includes a solvent (for example, THF) and a radical anion of an aromatic compound (for example, naphthalene). Some of the components of the liquid composition have a high activity, and thereby may adversely affect the cycle resistance of the battery. The higher the SOC of the battery is, the higher the electric potential of the positive electrode is. During CV charging, the positive electrode maintains its high electric potential. When components with high activity (for example, THF and/or naphthalene) come into contact with the positive electrode with high electric potential, the high activity may decrease. As a result, the cycle resistance of the battery may be improved.

The CV charging ends when termination conditions are satisfied. When the CV charging ends, the CCCV charging may also end. After the CV charging ends, CC charging may be performed.

The termination conditions for the CV charging may be its duration, for example. The CV charging duration may be from 0.5 hours to 100 hours, for example. The CV charging duration may be from 1 hour to 48 hours, for example. The CV charging duration may be from 1 hour to 24 hours, for example. The CV charging duration may be from 1 hour to 3 hours, for example.

The termination conditions for the CV charging may be its rate, for example. During the CV charging, the electric current decays. The CV charging may end when the rate has decayed to reach 0.05 C, for example. The CV charging may end when the rate has decayed to reach 0.03 C, for example. The CV charging may end when the rate has decayed to reach 0.01 C, for example.

For example, a charge-discharge cycle including CCCV charging may be performed. For example, CCCV charging and CC discharging may be repeated alternately. For example, CCCV charging and CCCV discharging may be repeated alternately. In the CCCV discharging, CC discharging and CV discharging are performed in this order, for example. The rate during the CC discharging may be from 0.1 C to 2 C, for example. The SOC during the CV discharging may be from 0% to 10%, for example.

The range of SOC in the charge-discharge cycle may be, for example, from 0% to 100%. For example, the CCCV charging may be performed from 0% SOC to 100% SOC. For example, the CC discharging may be performed from 100% SOC to 0% SOC. For example, the range of SOC in the charge-discharge cycle may be from 0% to 90%. For example, the CCCV charging may be performed from 0% SOC to 90% SOC. For example, the CC discharging may be performed from 90% SOC to 0% SOC.

In the present embodiment, a single charge-discharge cycle consists of “a single sequence of charging and discharging” or “a single sequence of discharging and charging”. When the charge-discharge cycle starts from charging, “a single sequence of charging and discharging” is a single charge-discharge cycle. When the charge-discharge cycle starts from discharging, “a single sequence of discharging and charging” is a single charge-discharge cycle. The number of charge-discharge cycles may be from 1 to 100, for example. The number of charge-discharge cycles may be from 5 to 100, for example. The number of charge-discharge cycles may be from 5 to 50, for example. The number of charge-discharge cycles may be from 10 to 50, for example. The number of charge-discharge cycles may be from 30 to 40, for example.

<Method of Producing Non-Aqueous Electrolyte Secondary Battery>

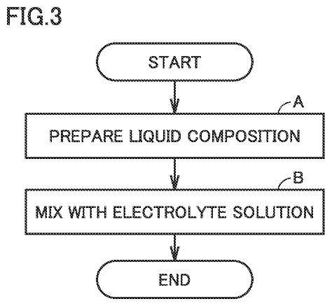

FIG. 3 is a first schematic flowchart of a method of producing a non-aqueous electrolyte secondary battery according to the present embodiment. In the present embodiment, a method of producing a battery is also provided. The method of producing a battery according to the present embodiment includes “(A) preparing a liquid composition” and “(B) mixing with an electrolyte solution”.

<<(A) Preparing Liquid Composition>>

The method of producing a battery according to the present embodiment includes preparing a liquid composition. The specific operation may be the same as in, for example, “(A) preparing a liquid composition” in the above-described “method of restoring capacity of a battery”.

<<(B) Mixing with Electrolyte Solution>>

The method of producing a battery according to the present embodiment includes mixing the liquid composition with an electrolyte solution of the battery. The specific operation may be the same as in, for example, “(B) mixing with an electrolyte solution” in the above-described “method of restoring capacity of a battery”.

In the method of producing a battery according to the present embodiment, the battery used as a starting material may be a used battery, for example. The battery used as a starting material may be an unused battery, for example. It is likely that the capacity of an unused battery is not substantially decreased. Typically, however, a film is formed on the negative electrode during battery production. As a result, the amount of carrier ions in an unused battery may also be decreased from the initial amount. By mixing the liquid composition with an electrolyte solution of an unused battery, a battery with an increased capacity may be produced. Such a battery with an increased capacity may have a capacity retention greater than 100%, for example.

When the battery is a used battery with a decreased capacity, mixing the liquid composition with the electrolyte solution may restore the capacity. In other words, a battery with a restored capacity may be newly produced.

<<(J) CCCV Charging>>>

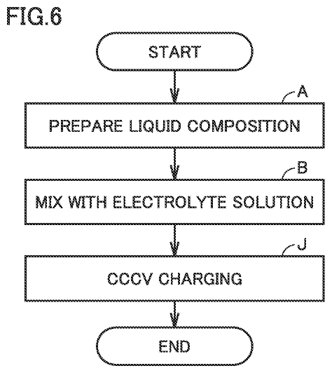

FIG. 6 is a second schematic flowchart of the method of producing a non-aqueous electrolyte secondary battery according to the present embodiment. The second schematic flowchart of FIG. 6 is the same as the first schematic flowchart of FIG. 3 with the addition of “(J) CCCV charging”.

The method of producing a battery according to the present embodiment may further include “(J) CCCV charging”, as in the above-described “method of restoring capacity of a battery”. In this configuration, a battery with excellent cycle resistance may be produced, for example.

<Non-Aqueous Electrolyte Secondary Battery>

In the present embodiment, a lithium-ion battery is described as an example. However, the battery should not be limited to a lithium-ion battery as long as it includes a non-aqueous electrolyte solution. The battery may be a sodium-ion battery or a magnesium-ion battery, for example.

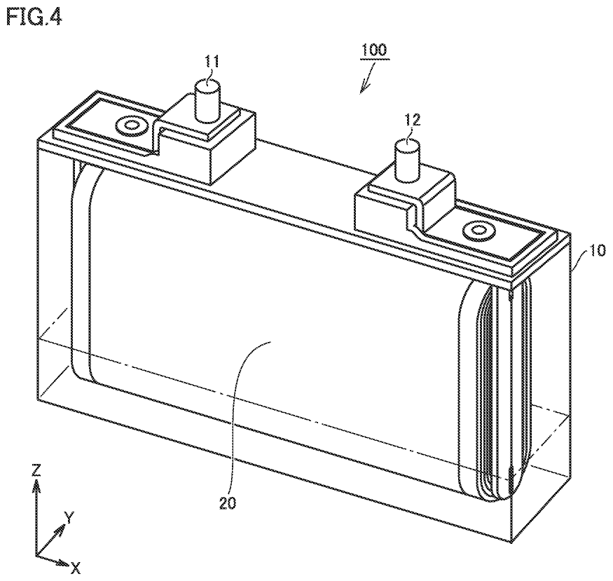

FIG. 4 is a schematic view illustrating an example configuration of a non-aqueous electrolyte secondary battery according to the present embodiment. A battery 100 is a so-called prismatic battery. However, the battery according to the present embodiment should not be limited to a prismatic battery. The battery may be a cylindrical battery, for example. The battery may be a pouch-type battery, for example. The pouch-type battery includes a pouch made of an aluminum-laminated film, as its housing.

Battery 100 includes a casing 10. Casing 10 may be a metal container, for example. Casing 10 is hermetically sealed. Casing 10 may be equipped with a positive electrode terminal 11, a negative electrode terminal 12, a liquid inlet (not illustrated), and the like, for example. The liquid inlet may be closed with a plug, for example. The structures of the liquid inlet and the plug may be designed to be detachable.

Casing 10 accommodates an electrode group 20 and an electrolyte solution. In FIG. 4, the dash-dot line shows the liquid level of the electrolyte solution. Electrode group 20 is electrically connected to positive electrode terminal 11 and negative electrode terminal 12. Electrode group 20 is immersed in the electrolyte solution.

<<Electrolyte Solution>>

The electrolyte solution includes a dissolved substance and a solvent. In the present embodiment, the liquid composition is mixed with the electrolyte solution. In the present embodiment, carrier ion feeding, for example, may have an effect such as mitigation of capacity loss occurring with use of battery 100.

(Dissolved Substance)

The dissolved substance includes a first dissolved substance component and a second dissolved substance component. The first dissolved substance component is a component originating from the dissolved substance (supporting salt) in the initial electrolyte solution. The initial electrolyte solution refers to the electrolyte solution before it is mixed with the liquid composition. The first dissolved substance component may have a concentration from 0.5 mol/L to 2.0 mol/L, for example. The first dissolved substance component may include, for example, at least one type selected from the group consisting of LiPF₆, LiBF₄, LiN(FSO₂)₂, and, LiN(CF₃SO₂)₂. When the first dissolved substance component dissociates, carrier ions (Li ions) and counter anions (for example, PF₆⁻) are produced.

The second dissolved substance component is a component originating from the dissolved substance of the liquid composition. The second dissolved substance component includes a radical anion of an aromatic compound and a metal cation (Li ion). In other words, the electrolyte solution according to the present embodiment includes a radical anion of an aromatic compound and a carrier ion. The aromatic compound is a polyacene or a polyphenyl.

(Solvent)

The solvent is aprotic. The solvent includes a first solvent component and a second solvent component. The first solvent component is a component originating from the solvent of the initial electrolyte solution. The first solvent component may include a cyclic carbonate and a chain carbonate, for example. The mixing ratio of the cyclic carbonate and the chain carbonate may be “(cyclic carbonate)/(chain carbonate)=1/9 to 5/5 (volume ratio)”, for example.

The cyclic carbonate may include at least one type selected from the group consisting of ethylene carbonate (EC), propylene carbonate (PC), butylene carbonate

(BC), vinylene carbonate (VC), vinylethylene carbonate (VEC), and fluoroethylene carbonate (FEC), for example.

The chain carbonate may include at least one type selected from the group consisting of dimethyl carbonate (DMC), ethyl methyl carbonate (EMC), and diethyl carbonate (DEC), for example.

The second solvent component is a component originating from the solvent of the liquid composition. The second solvent component may include a cyclic ether, a chain ether, and the like, for example. The second solvent component may include at least one type selected from the group consisting of THF, DOL, DX, DME, and DEE, for example. The second solvent component may include at least one type selected from the group consisting of THF and DME, for example.

(Other Components)

The electrolyte solution may further include an additive and the like in addition to the above-described components. The additive may include a film-forming agent, a flame retardant, and the like, for example.

<<Electrode Group>>

Electrode group 20 includes a positive electrode and a negative electrode. In other words, battery 100 includes a positive electrode, a negative electrode, and an electrolyte solution. Electrode group 20 may further include a separator. The separator is interposed between the positive electrode and the negative electrode.

Electrode group 20 is a wound-type one. More specifically, electrode group 20 may be formed by winding the positive electrode in a belt shape and the negative electrode in a belt shape, in a spiral fashion. However, the electrode group should not be limited to a wound-type one. The electrode group may be a stack-type one, for example. More specifically, the electrode group may be formed by alternately stacking one positive electrode and one negative electrode and then repeating this alternate stacking process more than once.

(Positive Electrode)

The positive electrode may be in sheet form, for example. The positive electrode includes a positive electrode active material. The positive electrode active material is not particularly limited. The positive electrode active material may include at least one type selected from the group consisting of lithium cobalt oxide, lithium nickel oxide, lithium manganese oxide, lithium nickel cobalt aluminate, lithium nickel cobalt manganese oxide, and lithium iron phosphate, for example.

The positive electrode may further include a current collector (for example, an aluminum foil), a conductive material (for example, acetylene black), a binder (for example, polyvinylidene difluoride), and the like, in addition to the positive electrode active material.

(Negative Electrode)

The negative electrode may be in sheet form, for example. The negative electrode includes a negative electrode active material. The negative electrode active material is not particularly limited. The negative electrode active material may include at least one type selected from the group consisting of graphite, soft carbon, hard carbon, silicon, silicon oxide, silicon-based alloy, tin, tin oxide, tin-based alloy, and lithium titanium oxide, for example.

The negative electrode may further include a current collector (for example, a copper foil), a conductive material (for example, acetylene black and/or carbon nanotubes), a binder (for example, styrene-butadiene rubber), and the like, in addition to the negative electrode active material.

(Separator)

The separator is an electrically insulating porous film. The separator is interposed between the positive electrode and the negative electrode. The separator separates the positive electrode from the negative electrode. The separator may include a polyethylene porous film, a polypropylene porous film, and/or the like, for example. The separator may include, for example, a heat-resistant layer on the surface thereof. The heat-resistant layer may include a heat-resistant material (for example, alumina).

### EXAMPLES

Next, examples according to the present disclosure (herein also called “the present example”) are described. However, the description below does not limit the scope of claims.

### Experiment 1

<<(A) Preparing Liquid Composition>>

(Nos. 1 to 4)

The materials described below were prepared.

Aromatic compound: naphthalene (powder)

Solvent: THF

Metal: Li

The materials were placed in a glove box. The glove box had an Ar atmosphere inside. The glove box had an environment with a low dew point, inside.

Naphthalene was added to THF to prepare a first mixture. The first mixture was stirred to dissolve the whole amount of naphthalene in THF. Thus, a precursor solution was prepared. The amount of naphthalene added was adjusted so that its concentration in a liquid composition (final product) was to be 0.1 mol/L.

Li was added to the precursor solution to prepare a second mixture. The second mixture was stirred to dissolve the whole amount of Li. The amount of Li added was adjusted so that its concentration in a liquid composition (final product) was to be 0.1 mol/L. It is considered that, in the solution, the reaction of the following formula (5) occurred to produce lithium naphthalenide.

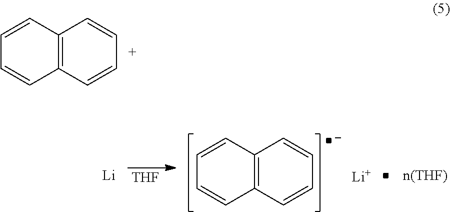

Thus, a liquid composition was produced. It is considered that the lithium naphthalenide concentration was 0.1 mol/L. The liquid composition was diluted or concentrated as appropriate to prepare liquid compositions Nos. 1 to 4, shown in Table 1 below.

(Nos. 5 and 6)

LiPF₆ was dissolved in THF to produce liquid composition No. 5. The LiPF₆ concentration was 0.10 mol/L.

LiPF₆ was dissolved in THF to produce liquid composition No. 6. The LiPF₆ concentration was 1.00 mol/L.

<<Preparing Battery>>

Three unused batteries and three used batteries were prepared. All of these unused batteries and used batteries were lithium-ion batteries.

<<Capacity Measurement>>

In accordance with the procedure described below, the capacity of each of the unused batteries and the used batteries was measured. Two plate-shaped materials were prepared. Each battery was interposed between these two plate-shaped materials. These two plate-shaped materials were fastened to each other so that a predetermined amount of load was applied to the battery. In this state, the battery was stored in a thermostatic chamber for three hours. The temperature inside the thermostatic chamber was set at room temperature.

After three hours of storage, the battery was connected to a charge-discharge apparatus. At a rate of 0.5 C, a single charge-discharge cycle was performed from 0% SOC to 100% SOC. The discharged capacity at this time was defined as “a pre-introduction capacity”. The pre-introduction capacity was divided by the initial capacity to calculate “a pre-introduction capacity retention”. Results are illustrated in Table 1 below.

The pre-introduction capacity retention of each unused battery was 100%. The pre-introduction capacity retention of each used battery was about 40%. In other words, the capacity of the used battery had a decrease of about 60%.

<<(B) Mixing with Electrolyte Solution>>

The SOC of each battery was adjusted to 50%. Each of liquid compositions Nos. 1, 2, and 5 was introduced into the unused battery. Each of liquid compositions Nos. 3, 4, and 6 were introduced into the used battery. Inside the battery, the liquid composition was mixed with an electrolyte solution. The same liquid composition was added in the same amount.

After the liquid composition was introduced, the battery was left to itself for 12 hours. After 12 hours, discharged capacity was measured in the same manner as described above. The discharged capacity at this time was defined as “a post-introduction capacity”. The post-introduction capacity was divided by the initial capacity to calculate “a post-introduction capacity retention”. Results are illustrated in Table 1 below.

Further, the post-introduction capacity retention was divided by the pre-introduction capacity retention to calculate “a ratio of pre- to post-introduction capacity retentions”. Results are illustrated in Table 1 below. A ratio of pre- to post-introduction capacity retentions greater than 1 means that the capacity increased between before introduction and after introduction.

TABLE 1

| | Liquid composition | | Battery | | |
|---|---|---|---|---|---|
| | Dissolved substance | | Pre- | Post- | Ratio of pre- to |
| | | Concen- | introduction | introduction | post-introduction |
| | | tration | capacity | capacity | capacity |
| No. | Type | [mol/L] | retention [%] | retention [%] | retentions [−] |
| 1 | Lithium | 0.05 | 100.0 | 104.5 | 1.04 |
| | naphthalenide | | | | |
| 2 | Lithium | 0.10 | 100.0 | 103.0 | 1.03 |
| | naphthalenide | | | | |
| 3 | Lithium | 0.50 | 41.5 | 60.8 | 1.47 |
| | naphthalenide | | | | |
| 4 | Lithium | 1.00 | 40.2 | 73.7 | 1.83 |
| | naphthalenide | | | | |
| 5 | LiPF₆ | 0.10 | 100.0 | 98.4 | 0.98 |
| 6 | LiPF₆ | 1.00 | 41.3 | 41.0 | 0.99 |

<Results of Experiment 1>

As for Nos. 1 to 4, mixing the liquid composition with the electrolyte solution increased the capacity. It is considered that Li ions of lithium naphthalenide were electrochemically inserted solely into the positive electrode.

As for Nos. 5 and 6, the capacity did not increase. It is considered that Li ions of LiPF₆ tend not to be spontaneously inserted into the positive electrode.

These results suggest that the ionic compound (for example, lithium naphthalenide) in the liquid composition according to the present disclosure has properties that are different from those of an ordinary supporting salt (for example, LiPF₆).

### Experiment 2

<<(A) Preparing Liquid Composition, (B) Mixing with Electrolyte Solution>>

Four used batteries were prepared. In the same manner as in Experiment 1, the capacity of each battery was measured. Thus, “a pre-cycle capacity retention” was calculated. The “pre-cycle capacity retention” is listed in Table 2 below. Each “pre-cycle capacity retention” was around 40%.

Liquid composition No. 4 in Experiment 1 was introduced into each battery. Inside the battery, the liquid composition was mixed with an electrolyte solution.

<<(J) CCCV Charging>>

(No. 7)

After the liquid composition was mixed, charge-discharge cycles were performed. The charge-discharge cycles in Experiment 2 included Step 1 and Step 2. First, Step 1 was performed. In Step 1, CCCV charging and CC discharging were alternately repeated under the conditions described below.

(Charge-Discharge Cycle Conditions in Step 1)

Temperature: 25° C.

CCCV Charging: CC charging rate=0.5 C, CV charging SOC=100%

CC Discharging: 0.5 C

Number of cycles: 36

After Step 1 ended, Step 2 was performed. In Step 2, CC charging and CC discharging were alternately repeated under the conditions described below.

(Charge-Discharge Cycle Conditions in Step 2)

Temperature: 25° C.

CC Charging: 0.5 C

CC Discharging: 0.5 C

SOC: from 0% to 100%

Number of cycles: 100

After Step 2 ended, the capacity of the battery was measured. Thus, “a post-cycle capacity retention” was calculated. The “post-cycle capacity retention” is listed in Table 2 below.

(Nos. 8 and 9)

Charge-discharge cycles were performed in the same manner as for No. 7 except that CV charging SOC in Step 1 was changed as specified in Table 2 below.

(No. 10)

As specified in Table 2 below, Step 1 was not performed and charge-discharge cycles in Step 2 were performed. The number of cycles was 118.

TABLE 2

| | Charge-discharge cycle | | | | | | | | | |
|---|---|---|---|---|---|---|---|---|---|---|
| | Step 1 | | | | | | | Evaluation | | |
| | CCCV Charging | | | | Step 2 | | | Pre-cycle | Post-cycle | Capacity |
| | CC | CV | CC | Number | CC | CC | Number | capacity | capacity | retention |
| | Charging | Charging | Discharging | of | Charging | Discharging | of | retention | retention | ratio |
| | Rate | SOC | Rate | cycles | Rate | Rate | cycles | (A) | (B) | (B/A) |
| No. | [C] | [%] | [C] | [-] | [C] | [C] | [-] | [%] | [%] | [-] |
| 7 | 0.5 | 100 | 0.5 | 36 | 0.5 | 0.5 | 100 | 38.6 | 69.4 | 1.8 |
| 8 | 0.5 | 90 | 0.5 | 36 | 0.5 | 0.5 | 100 | 39.1 | 68.5 | 1.8 |
| 9 | 0.5 | 0 | 0.5 | 36 | 0.5 | 0.5 | 100 | 37.3 | 40.7 | 1.1 |
| 10 | — | — | — | 0 | 0.5 | 0.5 | 118 | 44.1 | 26.0 | 0.6 |

<Results of Experiment 2>

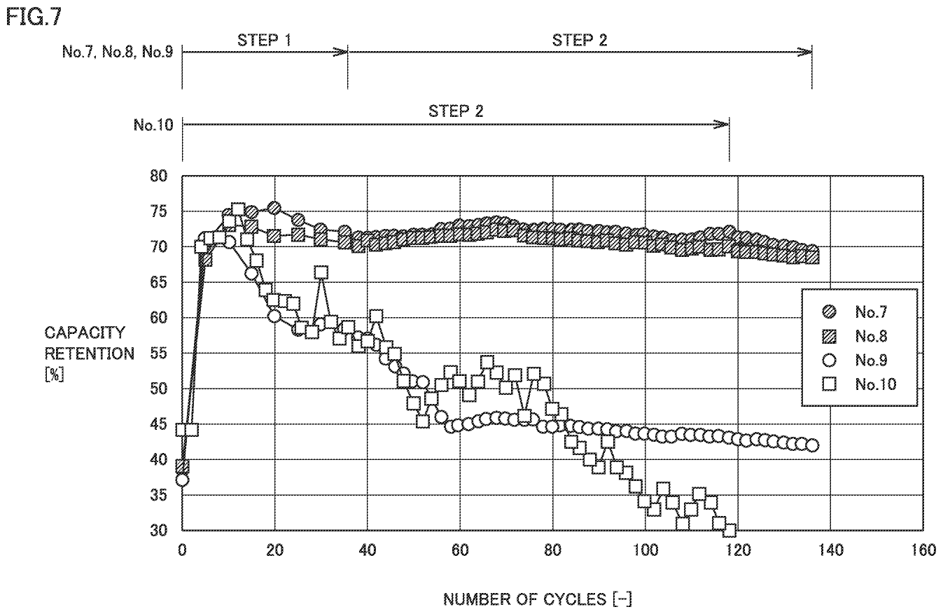

FIG. 7 is a graph illustrating results of charge-discharge cycles in Experiment 2.

As for Nos. 7 to 10, the capacity was greatly restored in early stages of the charge-discharge cycles (about 1st to 10th cycle).

As for No. 10, the capacity decreased in the subsequent charge-discharge cycles. For No. 10, charge-discharge cycles of Step 1 were not performed.

The capacity loss for No. 9 was not as sharp as that for No. 10. For No. 9, charge-discharge cycles of Step 1 were performed. The charge-discharge cycles of Step 1 included CCCV charging.

As for Nos. 7 and 8, a high capacity retention was maintained for an extended period of time. For Nos. 7 and 8, charge-discharge cycles of Step 1 were performed. The charge-discharge cycles of Step 1 included CCCV charging. For Nos. 7 and 8, CV charging in CCCV charging was performed at a high SOC (from 90% to 100%).

These results suggest that performing CCCV charging after introduction of the liquid composition into the battery may improve cycle resistance. It is considered that CCCV charging decreases the activity of some of the components of the liquid composition.

The present embodiments and the present examples are illustrative in any respect. The present embodiments and the present examples are non-restrictive. For example, it is expected that certain configurations of the present embodiments and the present examples can be optionally combined.

The technical scope defined based on the terms of the claims encompasses any modifications within the meaning equivalent to the terms of the claims. Further, the technical scope defined based on the terms of the claims encompasses any modifications within the scope equivalent to the terms of the claims.

What is claimed is:

1. A method of restoring capacity of a non-aqueous electrolyte secondary battery, comprising:
preparing a liquid composition; and
mixing the liquid composition with an electrolyte solution of the non-aqueous electrolyte secondary battery having an observed capacity loss from a predetermined capacity,
the liquid composition including a solvent and a dissolved substance,
the dissolved substance including an ionic compound,
the ionic compound consisting of a radical anion of an aromatic compound and a metal cation,
the aromatic compound being a polyacene or a polyphenyl,
the metal cation being an ion of the same type as carrier ions of the non-aqueous electrolyte secondary battery.

2. The method of restoring capacity of a non-aqueous electrolyte secondary battery according to claim 1, wherein the dissolved substance includes at least one type selected from the group consisting of:
a first ionic compound represented by the following formula (1): 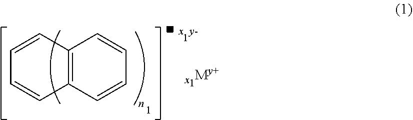
and a second ionic compound represented by the following formula (2): 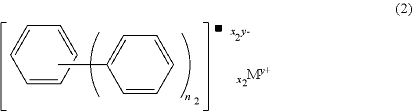
where
each of n₁ and n₂ is an integer of 1 to 4,
each of x₁ and x₂ is any numeral,
M^{y+} denotes the metal cation,
y denotes a valence of the metal cation,
each aromatic ring may include a heteroatom in the ring, and
each aromatic ring may have a substituent on the ring.

3. The method of restoring capacity of a non-aqueous electrolyte secondary battery according to claim 2, wherein the radical anion includes at least one type selected from the group consisting of a naphthalene radical anion and a biphenyl radical anion.

4. The method of restoring capacity of a non-aqueous electrolyte secondary battery according to claim 1, wherein the metal cation includes a lithium ion.

5. The method of restoring capacity of a non-aqueous electrolyte secondary battery according to claim 1, wherein the solvent includes at least one type selected from the group consisting of tetrahydrofuran and 1,2-dimethoxyethane.

6. The method of restoring capacity of a non-aqueous electrolyte secondary battery according to claim 1, further comprising:
after the liquid composition is mixed with the electrolyte solution of the non-aqueous electrolyte secondary battery, performing constant current-constant voltage charging of the non-aqueous electrolyte secondary battery.

7. The method of restoring capacity of a non-aqueous electrolyte secondary battery according to claim 6, wherein the constant current-constant voltage charging includes performing constant voltage charging of the non-aqueous electrolyte secondary battery in a 90% to 100% charged state.

8. A non-aqueous electrolyte secondary battery, comprising:
a positive electrode;
a negative electrode; and
an electrolyte solution,
the electrolyte solution including a solvent and a dissolved substance,
the dissolved substance including a radical anion of an aromatic compound and a carrier ion,
the aromatic compound being a polyacene or a polyphenyl.

9. The non-aqueous electrolyte secondary battery according to claim 8, wherein the radical anion includes at least one type selected from the group consisting of a naphthalene radical anion and a biphenyl radical anion.
